(19) United States
(12) Patent Application Publication
(10) Pub. No.: US 2017/0263908 A1
(43) Pub. Date: Sep. 14, 2017

(54) Separator For Use in Electrochemical Cells and Method of Fabrication Thereof

(71) Applicant: Giner, Inc., Newton, MA (US)

(72) Inventors: Castro Laicer, Watertown, MA (US); Mario Moreira, Hudson, MA (US); Katherine Harrison, Arlington, MA (US)

(21) Appl. No.: 15/453,409

(22) Filed: Mar. 8, 2017

Related U.S. Application Data
(60) Provisional application No. 62/305,158, filed on Mar. 8, 2016.

(51) Int. Cl. H01M 2/16; H01G 11/52; H01G 11/84; H01M 2/14

(52) U.S. Cl. CPC H01M 2/1686; H01M 2/162; H01M 2/1653; H01M 2/166; H01M 2/145; H01G 11/52; H01G 11/84

(57) ABSTRACT

An electrochemical cell, such as a capacitor or a secondary battery, is formed with a heat-resistant separator comprising a crosslinked membrane. The heat resistant separator is formed by exposing a polymeric membrane to a suitable condition, such as electron beam irradiation, to form the cross linked separator. In certain embodiments, the heat-resistant separator can be in the form of a laminate. In other embodiments, the heat-resistant separator includes inorganic particulate additives. The separator improves both safety and electrochemical performance of electrochemical cells, including lithium-ion batteries, such as by protecting against off-normal thermal abuse conditions and internal shorts from dendrite formation. The heat-resistant separator also provides improvements in high-rate and power density performance capabilities of secondary batteries.

### RELATED APPLICATION

This application claims the benefit of U.S. Provisional Application No. 62/305,158, filed on Mar. 8, 2016. The entire teachings of the above application are incorporated herein by reference.

### GOVERNMENT SUPPORT

This invention was made with government support under DOD SBIR Phase I Contract No. HQ0147-14-C-8306 from the Department of Defense, Defense Logistics Agency. The government has certain rights in the invention.

### FIELD OF THE INVENTION

This invention relates to a separator for use in electrochemical energy storage batteries, cells, and methods of preparing the separator.

### BACKGROUND OF THE INVENTION

Electrochemical cells, such as capacitors and secondary batteries (e.g., lithium-ion batteries, lithium-sulfur batteries, and lithium-air batteries), are attractive for many commercial applications such as aerospace, automotive, medical devices, and portable electronics because of their desirable volumetric and gravimetric energy density performance compared to other rechargeable battery systems. In the automotive industry, an important requirement for widespread market penetration for electric vehicles is development of higher energy and power density batteries that are more cost-effective, longer lasting, and abuse-tolerant. Li-ion batteries are currently the most promising power source technology for electric vehicles because of their improved volumetric and gravimetric energy density, and operating voltage range compared to nickel- and lead acid-based batteries.¹⁻³ With increasing advances in achieving higher energy density, safety remains a major performance challenge for Li-ion batteries.

Traditional commercial separators for Li-ion battery applications consist of microporous membranes that prevent contact between electrodes and enable free ion flow in the cell. Major drawbacks of these separators include their complex manufacturing process and insufficient safety protection against thermal runaway events during off-normal abuse conditions. Furthermore, standard commercial separators are not optimized for high-rate battery applications such as fast charging, fast discharging, or high rate pulse discharging. During off-normal operation conditions, such as external or internal short circuits, Li-ion cells can undergo exothermic, thermal runaway reactions that lead to a substantial temperature increase.⁴⁻⁶ The separator, a microporous membrane placed between the cathode and anode electrodes, plays a critical role in maintaining cell safety by preventing physical contact between the cathode and anode electrodes. The majority of state-of-the-art commercial separators are thin (˜25 μm), single-layer or tri-layer microporous polyolefin films, typically made of polyethylene (PE) or polypropylene (PP). Tri-layer separators (PP/PE/PP) are designed with a shutdown protection feature activated by a low-temperature melting PE middle layer when temperature reaches ˜130° C.^{7,8} Because tri-layer shutdown separators were originally designed for small format cells for consumer electronics, their abuse tolerance and shutdown feature are not reliable in larger format cells (>10 Ah) used in electric vehicles. Additionally, these materials do not provide thermal runaway protection at elevated temperatures beyond the melting point of PP (T˜165° C.).

To overcome safety limitations associated with traditional microporous separators, and to address the unique safety requirements of large format electric vehicle cells, newer generation separators based on ceramic composite materials have been developed. Examples include ceramic-coated or ceramic-filled polyolefin films,⁹ ceramic-embedded polyethylene terephthalate (PET) nonwoven supports,¹⁰ and all-ceramic separators formed by compositing inorganic particles with polymer binders.^{11,12} Overall, these materials have excellent dimensional stability with low shrinkage at elevated temperatures up to ˜200° C. Despite this feature, ceramic separators have several performance tradeoffs, which include shedding and delamination of the inorganic component and decreased permeability due to high loading and tight packing of inorganic particles. Furthermore, despite the inherent superior thermal stability of the ceramic particle additives, the maximum service temperature of ceramic separators is still limited by the melt integrity of the polymer binder used to form ceramic coating or impregnation composite layers.

Therefore, a need exists for an electrochemical cell that overcomes or minimizes the above-referenced problems.

### SUMMARY OF THE INVENTION

The invention generally is directed to an electrochemical cell, such as a secondary battery, and a method of making the electrochemical cell.

In one embodiment, the electrochemical cell of the invention includes an anode, a cathode, and a heat-resistant separator between the anode and the cathode, the separator including a crosslinked membrane.

In another embodiment, the invention is a method of making an electrochemical cell that includes the steps of fabricating a heat-resistant separator, and then assembling an anode and a cathode on either side of the separator to thereby form the electrochemical cell.

This invention has several advantages. For example, the heat-resistant separator of the electrochemical cell of the invention can withstand temperatures far in excess of those generally available. Further, the heat-resistant separator can be fabricated efficiently and can be in the form of a laminate. The heat-resistant separator improves both safety and electrochemical performance of secondary batteries, including lithium-ion (Li-ion) batteries, such as by protecting against off-normal thermal abuse conditions and internal shorts from dendrite formation. The heat-resistant separator also provides improvements in high-rate and power density performance capabilities of secondary batteries.

### BRIEF DESCRIPTION OF THE DRAWINGS

FIG. 1 is a schematic representation of a lithium ion battery cell incorporating one embodiment of the claimed separator.

FIG. 2 is a schematic representation of one embodiment of a method of making a separator of a secondary battery of the invention.

FIG. 3 is a schematic representation of another embodiment of a method of making a separator of a secondary battery of the invention.

FIGS. 4A-4C represent yet another embodiment of a method of making a separator of a secondary battery of the invention.

FIGS. 5A-5C are (A) a scanning electron micrograph (SEM) of the NF membrane separator; (B) corresponding fiber size distribution; and (C) a demonstration of flexibility of one embodiment of the NF separator employed to fabricate a secondary battery of the invention.

FIG. 6 is a plot of differential scanning calorimetry (DSC) cooling curves for EB-cross-linked NF separators of one embodiment of the invention. A control, non-EB crosslinked NF sample is shown for comparison. DSC scans were measured with heating and cooling rates of 10° C./min. Exothermic heat flow is up along the y-axis and endothermic heat flow is down along the y-axis.

FIGS. 7A-7F are SEM images of an EB-crosslinked NF separator exposed to a 300° C. oven soak for (A) 10 min and (B) 1 hr. SEM of “As Made” (non-crosslinked) NF separator (C) before and (D) after an oven soak test at 150° C. for 10 min, and an SEM of a state-of-the-art (SOA) commercial microporous PE membrane separator before (E) and after (F) an oven soak test at 150° C. for 10 min.

FIG. 8 is a plot of a comparison of electrolyte uptake for a separator (“EB-crosslinked NF Separator”) and a commercial separator (“Comparative Sample 1”). Data points are averages of three separate sample measurements.

FIG. 9 is a summary of physical properties of benchmark separators.

FIG. 10 are Arrhenius plots comparing ionic conductivity of a EB-crosslinked NF separator, employed in a secondary battery of the invention, to comparative separators. Measurements were done with 1M LiPF₆ in 3:7 v/v EC/EMC electrolyte. All measurements were done in triplicate experiments.

FIGS. 11A-11D represent capacity retention as a function of discharge rate for Li-ion cells incorporating EB-crosslinked NF separator and comparative separators: (A) LiNi_{0.5}Mn_{1.5}O₄/Li cells (LNMO half-cells), (B) LiNi_{0.5}Mn_{1.5}O₄/Graphite (LNMO full-cells), (C) LiFePO₄/Li cells (LFP half-cells), and (D) LiCoO₂/Li cells (LCO half-cells). Benchmark separators were “Comparative Sample 1” for LNMO-based cells and “Comparative Sample 4” for LiFePO₄ and LiCoO₂-based cells. Cells with commercial cathodes were activated with 1 M LiPF₆ in 1/1 EC/DMC. Charge-discharge voltage ranges were 3.6 V to 2.0 V for LiFePO₄, 4.2 V to 3.0 V for LiCoO₂, and 5.0 V to 3.0 V for LNMO cells. Data is average of three cells.

FIGS. 12A-12D are voltage profiles at different discharge rates as a function of discharge rate for: (A) LNMO half-cells, (B) LNMO full-cells, (C) LFP half-cells, and (D) LCO half-cells. Benchmark separators were “Comparative Sample 1” for LNMO-based cells and “Comparative Sample 4” for LiFePO₄ and LiCoO₂-based cells.

FIGS. 13A-13C are representations of (A) pulse load voltage profile for a LNMO full-cell built with an EB-crosslinked NF separator. (B) Pulse power densities of LNMO full-cells with NF and commercial benchmark separators. (C) Pulse power densities for commercial cells with EB-crosslinked NF and comparative separator. Pulse power density values are an average of three cells. Pulse discharge rates were 12 C (1.5 A/g) for LNMO, 40 C (8 A/g) for LiCoO₂, and 20 C (4 A/g) for LiFePO₄ cells. Current density (A/g) is based on weight of the active cathode material.

FIG. 14 are plots of cycle life of LNMO full-cells with EB-crosslinked NF separator compared to “Comparative Sample 1.” Data is average of three separate cell measurements.

FIGS. 15A and 15B are plots of capacity retention (A) and cell IR (B), as a function of cycle number for LiFePO₄ full-cells with NF separator and “Comparative Sample 4” separator. Data shown is an average of three cells.

FIG. 16 are cycle life evaluations of EB-crosslinked NF separators compared to benchmark commercial separators in NMC/graphite full-cells. Charge-discharge rate is C/5. All cells were activated with 1M LiPF₆ in 3:7 v/v EC/EMC electrolyte.

FIG. 17 shows cell internal resistance (IR) measurements for LNMO half-cells as a function of high-temperature cycling. Cells were activated with 1M LiPF6 in 1/1/1 EC/DEC/DMC with 1% VC (VC is vinylene carbonate). IR measurements were taken during open-circuit voltage (OCV) periods after charge. Cells were cycled at a C/5 rate. The data shown is an average of three cells.

FIGS. 18A and 18B represent (A) discharge capacity and (B) IR for LNMO full-cells as a function of low-temperature cycling. IR measurements were taken during open-circuit voltage (OCV) periods after charge. Cells were cycled at a C/5 rate. The data shown is an average of three cells.

FIGS. 19A-19B represent (A) discharge capacity and, (B) IR for LNMO full-cells as a function of low-temperature cycling. Cells were activated with 1M LiPF₆ in 1/1/1 EC/DEC/DMC with 1% VC (VC is vinylene carbonate). IR measurements were taken during open-circuit voltage (OCV) periods after charge. Cells were cycled at a C/5 rate. Data is an average of three cells.

FIGS. 20A-20B represent (A) discharge capacity and (B) IR for LNMO full-cells as a function of low-temperature cycling. IR measurements were taken during open-circuit voltage (OCV) periods after charge. Cells were cycled at a C/5 rate. The data shown is an average of three cells.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

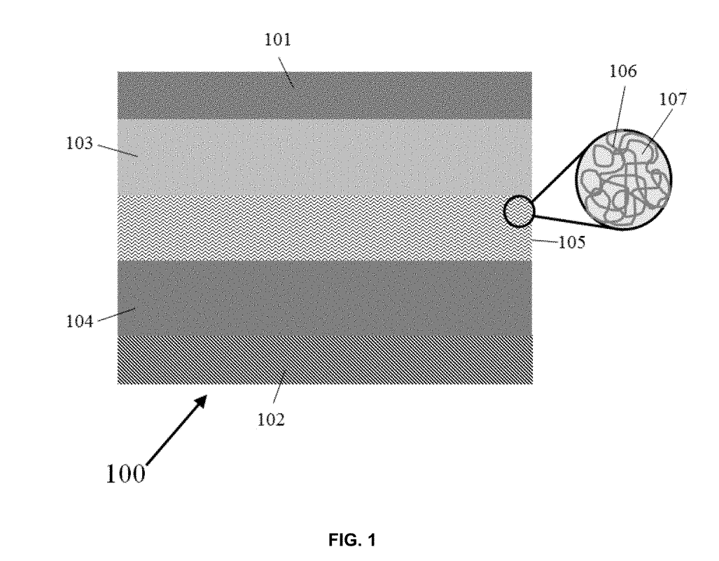

This invention includes, in one embodiment, an electrochemical cell, such as a capacitor or secondary battery (e.g., a lithium-ion battery, a lithium sulfur battery or a lithium-air battery), that employs a crosslinked, polymer nonwoven fiber separator (FIG. 1). Referring now to FIG. 1, there is schematically shown a side view of one embodiment of a secondary battery 100. The secondary battery 100 may comprise conductive substrates 101 and 102, cathode 103, anode 104, and heat-resistant separator 105. A “heat-resistant separator,” as that term is employed herein, means a separator having at least one phase having a melting point of more than 200° C. or that does not melt. The heat-resistant separator may comprise a crosslinked, polymer nonwoven fiber mat 106 that is impregnated with liquid electrolyte 107. The separator is produced by forming a polymer fiber nonwoven membrane by electrospinning (E-spinning) or other fiber manufacturing techniques, followed by cross-linking via electron beam (EB) or gamma irradiation. EB irradiation is a low-energy, room temperature, and solvent-free process that enables fast and efficient cross-linking of solid polymer fiber nonwoven membranes. EB-crosslinking imparts high-temperature, melt resistant properties to the manufactured battery nonwoven separator. EB-crosslinking also improves mechanical properties of the nonwoven separator after it is soaked with liquid battery electrolyte during cell assembly and applications. The crosslinked nonwoven separator can be manufactured onto a carrier substrate such as polyethylene terephthalate (PET), polypropylene (PP), or cellulose-based nonwovens for improved handling. Prior to assembly inside a battery cell, the manufactured separator is delaminated from the carrier substrate and used as a freestanding nonwoven membrane separator in cell applications.

In another aspect of this invention, the separator is produced by coating the crosslinked, polymer fiber nonwoven membrane onto one or both sides of a wet-laid nonwoven support. This entire composite structure (crosslinked nonwoven membrane plus wet-laid nonwoven support) is used as the separator in battery cell assembly and applications.

In another aspect of this invention, the separator is produced by coating the crosslinked, polymer fiber nonwoven membrane onto one or both sides of a microporous polyolefin membrane. This entire composite structure (crosslinked nonwoven membrane plus microporous polyolefin membrane) is used as the separator in cell assembly and applications.

In another aspect of this invention, the crosslinked NF membrane separator is manufactured by coating directly onto one side or both sides of pre-manufactured battery cathode and anode electrodes.

In another aspect of this invention, the separator is produced by coating the crosslinked, polymer fiber nonwoven membrane onto one or both sides of a phase inversion membrane. This entire composite structure (crosslinked nonwoven membrane plus phase inversion membrane) is used as the separator in cell assembly and applications. In another aspect of this invention, the crosslinked NF membrane separator is manufactured by coating directly onto pre-manufactured battery electrodes.

The above-described nonwoven membrane separator structures are versatile and may incorporate: (1) a single nonwoven layer of crosslinked, melt-resistant fibers; (2) a single nonwoven layer containing low-melt-temperature fibers intermingled (blended, or mixed) with crosslinked, melt-resistant fibers; or (3) a multi-layered nonwoven structure that contains discreet layers of low-melt-temperature fibers and crosslinked, melt-resistant fibers. Low-melt-temperature fibers refers to polymer fibers with a melt temperature (Tₘ) below 200° C., and preferably below 150° C. while melt-resistant fibers refers to chemically crosslinked fibers that do not melt or that have a Tₘ greater than 200° C. During cell abuse failure events that lead to a rapid increase in temperature, the low-melt-temperature fibers provide shutdown function by melting and inhibiting lithium-ion transport between the cathode and anode electrode, while the crosslinked, melt-resistant fibers provide the separator with mechanical strength to avoid internal shorts caused by contact between the cathode and anode electrodes.

In another aspect of this invention, the above-described nonwoven separator structures may also contain inorganic particle additives composited and embedded within the polymer matrix of the crosslinked fiber nonwovens. The particle additives improve dimensional stability and mechanical properties of the separator during high temperature abuse conditions.

In another aspect of this invention, the battery separator may comprise a porous polymer membrane prepared by phase inversion techniques, followed by crosslinking to impart high-temperature melt resistant properties. Cross linking of the porous phase inversion membrane can be done by electron beam or gamma irradiation. The crosslinked, phase inversion membrane separator can be also prepared by solution coating directly onto pre-fabricated battery electrode substrate films or onto another substrate carrier film. The crosslinked, phase inversion membrane separator may also be composited with inorganic particle additives to enhance dimensional stability and mechanical properties of the separator during high temperature abuse conditions. One common method for preparing porous phase inversion membranes involves casting a polymer solution onto a suitable substrate, followed by submerging the wet polymer film into a coagulation bath containing non-solvent. Polymer precipitation occurs due to an exchange of solvent used for the polymer solution and the coagulation bath, thus creating a porous membrane film.

In another aspect of this invention, the battery separator may comprise a phase inversion porous membrane coated onto a polyolefin microporous separator, followed by crosslinking of the phase inversion membrane to impart high-temperature melt resistant properties. Cross linking can be done by electron beam or gamma irradiation. This entire composite structure (crosslinked phase inversion membrane plus microporous polyolefin membrane) is used as the separator in battery cell assembly and applications. The crosslinked, phase inversion membrane may also be composited with inorganic particle additives to enhance dimensional stability and mechanical properties of the separator during high temperature abuse conditions.

In another aspect of the invention, the battery separator may comprise a non-porous membrane prepared by a solution coating technique without a phase inversion step, followed by crosslinking of the dried polymer film to impart high-temperature melt resistant properties. Cross linking can be done by electron beam or gamma irradiation. The crosslinked, non-porous membrane separator can be prepared by solution coating onto a suitable carrier support film or by coating directly onto pre-fabricated battery cathode and anodes electrodes. The crosslinked, non-porous membrane separator may also be composited with inorganic particle additives to enhance dimensional stability and mechanical properties of the separator during high temperature abuse conditions. The crosslinked, non-porous membrane separator functions as a polymer gel electrolyte when impregnated and activated with liquid electrolyte in secondary battery applications.

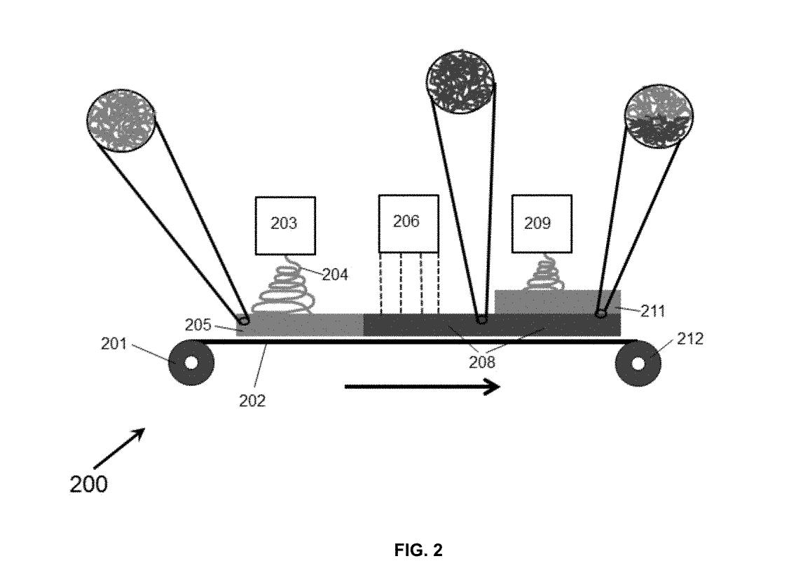

The separator described in this invention is manufactured by electrospinning to form a polymer fiber nonwoven membrane, followed by cross-linking of the fibers via methods such as electron beam or gamma irradiation. An additional layer of electrospun fibers can then be laid (FIG. 2). Referring now to FIG. 2, there is schematically shown one embodiment of fabricating the heat-resistant separator. The fabrication includes a roll-to-roll process 200, with unwind 201 and rewind 212 rollers that transport a battery electrode (or other substrate) 202 under electrospinning fiber emitters (203, 209) and an electron beam emitter 206. An electrospinning fiber emitter 203 creates a fiber 204 which coats the support substrate as a non-crosslinked nonwoven mat 205. The nonwoven mat is crosslinked as it passes under an electron beam emitter 206. Following electron beam exposure, the crosslinked nonwoven mat 208 is transported under an electrospinning fiber emitter 209 which coats one layer of a non-crosslinked nonwoven mat 211 on top of the crosslinked nonwoven mat 208. The resulting heat-resistant separator consists of a multi-layer nonwoven structure with each layer having a distinct melting point. For example, the crosslinked nonwoven layer may melt at a temperature higher than 200° C. or not melt at all, while the non-crosslinked nonwoven layer may melt below 200° C. A melting temperature lower than 150° C. is preferred for the non-crosslinked nonwoven layer to enable shutdown function of the secondary battery. Additionally, multiple co-electrospinning fiber emitters may be combined along the machine width and machine direction to prepare fiber nonwoven mats with multiple distinct physical properties (such as fiber melting temperatures, fiber diameter, porosity) in the same layer. For example, the crosslinked nonwoven layer 208 and the non-crosslinked nonwoven layer 211 may each have fibers with multiple distinct physical properties in the same layer. To enable formation of nonwoven mats with multiple distinct physical properties in the same layer, multiple co-electrospinning fiber emitters may be used, which may incorporate different types and concentrations of polymers, crosslinker compounds, and inorganic particle additives.

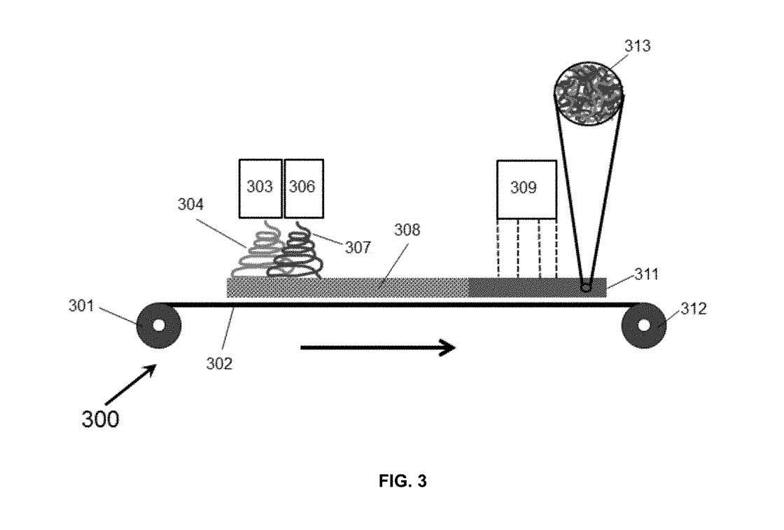

In another embodiment, shown in FIG. 3, the melt-resistant separator can be formed with low melting and melt-resistant fibers in the same nonwoven layer structure. Referring now to FIG. 3, there is schematically shown one embodiment of fabricating the heat-resistant separator. The fabrication includes a roll-to-roll process 300, with unwind 301 and rewind 312 rollers that transport a battery electrode (or other substrate) 302 under co-electrospinning fiber emitters (303, 306) and an electron beam emitter 309. The two co-electrospinning fiber emitters (303, 306) simultaneously create two distinct fibers (304, 307) which are intermingled to form a non-crosslinked nonwoven mat 308 on the substrate support. The nonwoven mat is exposed to electron beam irradiation 309. The resulting heat-resistant separator consists of a nonwoven layer 311 which contains a mixture of two fibers 313 with distinct melting points. For example, in the same nonwoven layer 311, one type of fiber may have a melt temperature higher than 200° C. or not melt, while the other fiber may melt below 200° C. A melting temperature lower than 150° C. is preferred for the lower melting fibers for shutdown function. To enable different melting properties, fibers 304 and 307 may be formed with different types and concentrations of polymers, crosslinker compounds, and inorganic particle additives. Additionally, any combination of co-electrospinning fiber emitters can be combined along the machine width and machine direction to prepare fiber nonwoven mats with multiple distinct physical properties (such as fiber melting temperatures, fiber diameter, porosity) in the same layer.

The fiber-forming process is not limited to electrospinning and may include other fine fiber manufacturing techniques such as melt-blowing, bi-component melt-blowing, island-sea melt-spinning, electro-blowing, force spinning, and combinations of these methods. The fiber forming process may include a polymer solution-based method or a polymer melt-based method. The fiber manufacturing process and EB cross-linking technologies can be integrated into existing high-volume, roll-to-roll battery electrode production lines. In E-spinning, fibrous nonwoven membranes are formed by drawing fibers from a polymer solution with an applied electric charge. The resulting membranes are produced as nonwoven films with homogenous, nanoscale-sized fibers.^{13,14} The prepared nonwoven mats can also be post-processed using a calendaring roll at room temperature or elevated temperature. The calendaring step densifies and decreases thickness of the nonwoven membrane separator. A hot calendaring step done prior to EB-crosslinking can partially melt the polymer fibers to improve fiber-to-fiber bonding in the membrane separator, which results in improved mechanical properties. Compared to conventional “dry” and “wet” manufacturing processes used to make traditional PE and PP-based microporous Li-ion battery separators, the nonwoven fiber separator method provides an alternative separator structure with inherent physical properties that are attractive for Li-ion battery applications. These advantages include a more simplified separator manufacturing process, higher porosity (50 to 90% porosity), improved electrolyte wettability and uptake, and improved adhesion to electrode surfaces. Taken together, these performance features improve high rate and power density performance. Additionally, the tortuous three-dimensional structure of the nonwoven fiber membrane separator is more effective for blocking dendrite growth compared to traditional commercial separators.

EB technology, which is employed to impart high-temperature melt resistance in the separator, is a low-energy, room-temperature, and solvent-free process that enables fast and efficient cross-linking of solid polymer membranes, including fiber nonwoven membranes, and is compatible with high-speed, roll-to-roll manufacturing.^{15,17} The EB-beam crosslinking makes the separator resistant to melting at high temperatures during catastrophic cell failure events. Furthermore, EB-crosslinking also makes the separator resistant to solvent and Li-ion electrolyte dissolution. In this invention, the separators can be manufactured by combining fiber forming and E-Beam crosslinking technologies in a stepwise process that involves forming fiber nonwoven membranes, followed by crosslinking with E-Beam irradiation. The crosslinked fiber nonwoven membranes can be calendared at room temperature or at elevated temperature. EB-crosslinking of the nonwoven membrane separator can be done with or without cross-linker additive (0 to 50 wt % crosslinker relative to solid polymer) and using an irradiation dose range of 10 to 1000 kGy. A continuous roll-to-roll EB machine can be used with a continuous nitrogen purge over the sample to eliminate unwanted side reactions during EB irradiation.

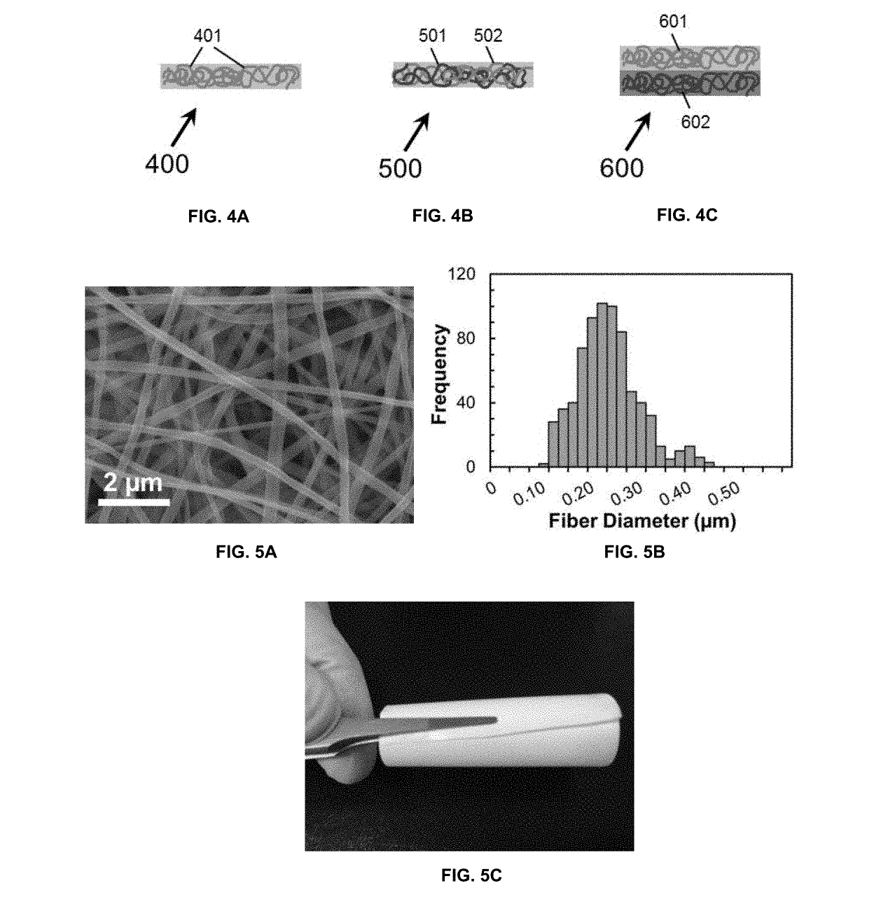

This process is versatile and may incorporate separator structures that consist of: (1) a membrane with a single layer of EB-crosslinked, melt-resistant fibers (FIG. 4A); (2) a membrane with low-melt-temperature fibers intermingled (blended, or mixed) with EB-crosslinked, melt-resistant fibers (FIG. 4B); or (3) a membrane structure that incorporates separate layers of low-melt-temperature nanofibers and EB crosslinked, melt-resistant fibers (FIG. 4C). Referring now to FIG. 4A, there is schematically shown a nonwoven single-layer 400 containing one type of fiber 401 that is uniformly crosslinked. The nonwoven layer 400 has one distinct melting temperature above 200° C. or does not melt. Referring now to FIG. 4B, there is schematically shown a single nonwoven layer 500 containing two types of fibers 501 and 502, each having distinct melt properties. For example, fiber 501 may have a melt temperature above 200° C. or does not melt, while fiber 502 may have a melt temperature below 200° C. Referring now to FIG. 4C, there is schematically shown a nonwoven multi-layer 600 containing two distinct nonwoven layers 601 and 602 with each having distinct melt properties. For example, nonwoven layer 601 may have a melt temperature above 200° C. or does not melt, while nonwoven layer 602 may melt below 200° C. The heat resistant separators described in this invention are impregnated with liquid electrolyte during battery cell assembly and applications. During cell abuse failure events involving a rapid increase in cell temperature, the low-melt-temperature fibers melt and inhibit lithium-ion transport between the cathode and anode electrodes, while the EB crosslinked, melt-resistant fibers provide the separator with mechanical strength to avoid internal shorts caused by contact between the cathode and anode electrodes.

The total thickness of the described heat-resistant nonwoven separator can range from 10 μm to 100 μm. The fiber diameter can range from ˜0.05 μm to 10 μm. The separator can also include structures comprising different fiber sizes. For example, larger micron-sized fibers (diameter >1 μm) for enhanced mechanical integrity may be combined and mixed with smaller, submicron-sized fibers (diameter <1 μm) to reduce separator pore size for improved lithium dendrite suppression. The crosslinked fiber nonwoven separator can be manufactured onto any suitable carrier substrate such as polyethylene terephthalate (PET) or polypropylene (PP) nonwovens for improved handling. Prior to assembly inside a battery cell, the manufactured separator is delaminated from the carrier substrate and used as a freestanding membrane separator in battery cell applications.

In another aspect of this invention, the separator is produced by coating the EB-crosslinked fiber nonwoven membrane onto one or both sides of a wet-laid nonwoven support. This entire composite structure (crosslinked nonwoven membrane plus wet-laid nonwoven support) is used as the separator in battery cell assembly without delamination from the nonwoven support carrier. The wet-laid nonwoven support can comprise polyethylene terephthalate (PET), polypropylene (PP), polyethylene (PE), or PP-PE core-sheath fibers. The total thickness of the wet-laid nonwoven support plus EB-crosslinked fiber nonwoven membrane can range from 10 μm to 100 μm.

In another aspect of this invention, the separator is produced by coating the crosslinked fiber nonwoven membrane onto one or both sides of a microporous polyolefin membrane. The entire composite structure (crosslinked nonwoven membrane plus microporous polyolefin membrane) is used as the separator in cell assembly and applications. The total thickness of the entire composite structure can range from 10 μm to 100 μm.

In another aspect of this invention, the crosslinked nonwoven membrane separator is manufactured by coating directly onto pre-manufactured battery electrodes.

Examples of polymers that can be used to prepare fibers of the heat-resistant nonwoven separators can include, but are not limited to: a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof. The polymer fibers of the nonwoven membrane separator may also comprise mixtures of two or more of these polymers. The fluoropolymers used to make the melt resistant separator are perfluorinated or partially fluorinated polymers made with monomers containing one or more atoms of fluorine, such as tetra- and trifluoroethylene, vinylidine fluoride, vinyl fluoride, hexafluoropropylene, hydropentafluoropropylene, chlorotrifluorethylene, hexafluoroisobutylene, fluorovinyl ether, perfluoropropyl vinyl ether, perfluoromethyl vinyl ether, fluoroethylene vinyl ether, acrylates such as perfluorooctyl acrylate, perfluorobutyl acrylate, and perfluorooctylsulfonamidoethyl acrylate. The fluoropolymers can also include copolymers or terpolymers containing one or more perfluorinated, partially fluorinated, or non-fluorinated monomer. Non-fluorinated monomers that are copolymerized with one or more fluorine containing monomers include vinyl chloride, ethylene, propylene, or methyl vinyl ether. Examples of fluorinated polymers include but are not limited to: poly(vinylidene fluoride) (PVDF), poly(vinylidene fluoride-co-hexafluoropropylene) (PVDF-co-HFP), poly(vinylidene fluoride-co-tetrafluoroethylene) (PVDF-co-TFE), poly(vinylidene fluoride-co-chlorotrifluoroethylene) (PVDF-co-CTFE), poly(vinylidene fluoride-co-hexafluoropropylene-co-tetrafluoroethylene) (PVDF-co-HFP-co-TFE), ethylene-tetrafluoroethylene (ETFE) copolymers, hexafluoropropylene-tetrafluoroethylene (FEP) copolymers, tetrafluoroethylene-perfluoro(alkoxy alkane) (PFA) copolymers, hexafluoropropylene-tetrafluoroethylene-ethylene (HTE) terpolymers, fluorinated poly(meth)acrylate, and mixtures thereof. The polymer fibers in the nonwoven separators described above can be crosslinked, by electron beam or gamma irradiation. Irradiation crosslinking may be done without additives, or with added mono-functional or multifunctional monomers, oligomers, and high molecular weight additive compounds. The crosslinker compounds can contain allyl functional groups. The crosslinker compounds are added and blended with the polymer solution during the fine fiber production process. Examples of crosslinker additives include: triallyl-cyanurate (TAC), triallyl-isocyanurate (TAIC), meta-phenylene dimaleimide (MPDM), trimethyolpropane trimethacrylate (TMPTMA), trimethyolpropane triacrylate (TMPTA), polyhedral oligomeric silsesquioxane (POSS) compounds, and mixtures thereof.

POSS additives consist of an inorganic silsesquioxane cage core, and organic functional groups attached at the corners of the cage which may crosslink with the polymer host matrix of the nonwoven membrane separator fibers. Addition of POSS additives enhances several physical properties of the host polymer material such as: (1) higher mechanical properties (e.g., increased modulus and hardness while maintaining the same stress and strain characteristics of the host polymer); (2) higher use temperature (e.g., increased glass transition temperature of the host polymer); and (3) enhanced fire retardation properties (reduced heat evolution and a delayed combustion temperature). Examples of multifunctional POSS additives that can be used in this invention include but are not limited to acrylo POSS (product no. MA0736, Hybrid Plastics), methacryl POSS (product no. MA0735, Hybrid Plastics), vinyl POSS (OL1170, Hybrid Plastics), and trisnorbornenyllsobutyl POSS (NB1070, Hybrid plastics). Alternatively, the POSS additives can also contain an inorganic silsesquioxane cage core and organic mono-functional groups attached on one corner of the cage, which can polymerize and graft onto the backbone of the polymer host matrix of the fiber nonwoven membrane separator. Examples of mono-functional POSS additives include but are not limited to acrylolsobutyl POSS (product no. MA0701, Hybrid Plastics), methacrylolsobutyl POSS (product no. MA0702, Hybrid Plastics), methacrylate isobutyl POSS (product no. MA0706, Hybrid Plastics), methacrylate ethyl POSS (product no. MA0716, Hybrid Plastics), methacrylethyl POSS (product no. MA0717, Hybrid Plastics), methacrylate isooctyl POSS (product no. MA0718, Hybrid Plastics), methacryllsooctyl POSS (product no. MA0719, Hybrid Plastics), norbornenylethyl disilanollsobutyl POSS (product no. NB1038, Hybrid Plastics), allysobutyl POSS (product no. OL1118, Hybrid Plastics), and vinyllsobutyl POSS (product no. OL1123, Hybrid Plastics). The fibers of the nonwoven membrane separator may also be crosslinked with mixtures of two or more crosslinker additive compounds. For example, TAIC and POSS-based crosslinkers may be mixed together for enhanced E-beam crosslinking of the polymer fibers in the nonwoven separator. The use of fluoropolymers such as PVDF-co-HFP in the described separators is advantageous because of their enhanced chemical and electrochemical stability in battery cell applications, especially for high voltage cell operation (e.g. charge voltage of up to 5V and above). EB-crosslinking of fluorinated polymers such as PVDF-co-HFP is also advantageous in this invention because non-crosslinked fiber nonwoven membrane separators have poor mechanical properties when swollen with battery liquid electrolyte, thus causing excessive internal shorts and cell failure during battery cell assembly and operation. The fiber nonwoven separators described above may also contain inorganic particle additives composited within the polymer matrix of the EB-crosslinked fibers. The particle additives improve dimensional stability and mechanical properties of the separator during cell high temperature exposure. Particle additives can include, but are not limited to inorganic particles such as nano-sized TiO₂, Al₂O₃, BaTiO₃, SiO₂, and nanoclays.

In another aspect of this invention, the battery separator may comprise a porous, phase inversion membrane. The porous phase inversion membrane can be prepared by solution casting and phase inversion techniques, followed by crosslinking to impart high-temperature melt resistant properties. Crosslinking is achieved by EB or gamma irradiation. The phase inversion porous membrane can be prepared by solution coating directly onto a pre-fabricated battery electrode substrate film or onto another substrate carrier film, followed by phase inversion. Examples of polymers that can be used to prepare the described crosslinked, phase inversion porous membrane include, but are not limited to a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof. The porous phase inversion membrane may also comprise mixtures of two or more polymers. The phase inversion porous membrane separator can be crosslinked without additives. Alternatively, the phase inversion porous membrane can be crosslinked with monofunctional or multifunctional monomers, oligomers, and high molecular weight compound additives that are crosslinked within the polymer matrix of the fine fibers. Examples of crosslinker additives include: triallyl-cyanurate (TAC), triallyl-isocyanurate (TAIC), meta-phenylene dimaleimide (MPDM), trimethyolpropane trimethacrylate (TMPTMA), trimethyolpropane triacrylate (TMPTA), polyhedral oligomeric silsesquioxane (POSS) compounds, and mixtures thereof.

The crosslinked, phase inversion membrane separator may also be composited with inorganic particle additives to enhance dimensional stability and mechanical properties of the separator during cell high temperature exposure. Particle additives can include, but are not limited to inorganic particles such as nanosized TiO₂, Al₂O₃, and SiO₂, and nanoclays.

In another aspect of this invention, the battery separator may comprise coating at least one layer of a polymer fiber nonwoven onto one or both sides of a phase inversion porous membrane, followed by EB crosslinking. The phase inversion porous membrane can be prepared by solvent casting and phase inversion techniques. This entire composite structure (crosslinked nonwoven layer plus phase inversion porous membrane) is used as the separator in battery cell assembly and applications. Examples of polymers that can be used to prepare the crosslinked fiber nonwoven layer plus phase inversion porous membrane include, but are not limited to: a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof. The fiber nonwoven and phase inversion membrane may also comprise mixtures of two or more polymers. The nonwoven layer and microporous composite separator may be crosslinked by electron beam and gamma irradiation. Crosslinking may be done without crosslinker compounds, or alternatively can be prepared with monofunctional or multifunctional monomers, oligomers, and high molecular weight compound additives that are crosslinked within the polymer matrix of the fine fibers. Examples of crosslinker additives include: triallyl-cyanurate (TAC), triallyl-isocyanurate (TAIC), meta-phenylene dimaleimide (MPDM), trimethyolpropane trimethacrylate (TMPTMA), trimethyolpropane triacrylate (TMPTA), polyhedral oligomeric silsesquioxane (POSS) compounds, and mixtures thereof. The polymer fiber nonwoven layer and phase inversion porous membrane may also be EB-crosslinked with mixtures of two or more crosslinker additive compounds. For example, TAIC and POSS-based additive compounds may be mixed for enhanced E-beam crosslinking of the polymer fibers in the nonwoven separator. The prepared crosslinked, polymer fiber nonwoven layer and phase inversion membrane may also be composited with inorganic particle additives to enhance dimensional stability and mechanical properties of the separator during cell high temperature exposure. Particle additives can include, but are not limited to inorganic particles such as nanosized TiO₂, Al₂O₃, and SiO₂, and nanoclays.

In another aspect of this invention, the battery separator may comprise a crosslinked, phase inversion porous membrane coated onto one or both sides of a microporous polyolefin membrane. Crosslinking may be done with EB and gamma irradiation. The entire composite structure (crosslinked phase inversion porous membrane plus microporous polyolefin membrane) is used as the separator in battery cell assembly and applications. Examples of polymers that can be used to prepare the described phase inversion membrane include, but are not limited to: a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof. The phase inversion membrane may also comprise mixtures of two or more polymers. The phase inversion membrane can be irradiation crosslinked without crosslinker compounds, or alternatively can be prepared with monofunctional or multifunctional monomers, oligomers, and high molecular weight compound additives that are crosslinked within the polymer matrix of the fine fibers. Examples of crosslinker additives include: triallyl-cyanurate (TAC), triallyl-isocyanurate (TAIC), meta-phenylene dimaleimide (MPDM), trimethyolpropane trimethacrylate (TMPTMA), trimethyolpropane triacrylate (TMPTA), polyhedral oligomeric silsesquioxane (POSS) compounds, and mixtures thereof. The phase inversion porous membrane may also be crosslinked with mixtures of two or more crosslinker additive compounds. For example, TAIC and POSS-based additive compounds may be added for enhanced E-beam crosslinking of the polymer fibers in the nonwoven separator. The porous phase inversion membrane may also be composited with inorganic particle additives to enhance dimensional stability and mechanical properties of the separator during cell high temperature exposure. Particle additives can include, but are not limited to inorganic particles such as nanosized TiO₂, Al₂O₃, and SiO₂, and nanoclays.

In another aspect of the invention, the battery separator may comprise a non-porous membrane that is prepared by a solution casting technique without a phase inversion step, followed by solvent drying and irradiation crosslinking to impart high-temperature melt resistant properties. The non-porous membrane may also be prepared by solution coating directly onto a pre-fabricated battery electrode substrate film or onto another substrate carrier film, followed by solvent drying and irradiation crosslinking. Examples of polymers that can be used to prepare the described non-porous membrane include, but are not limited to: a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof. The non-porous membrane may also comprise mixtures of two or more polymers. The non-porous membrane can be crosslinked without additives, or alternatively can be prepared with monofunctional or multifunctional monomers, oligomers, and high molecular weight compound additives that are crosslinked within the polymer matrix of the fine fibers. Examples of crosslinker additives include: triallyl-cyanurate (TAC), triallyl-isocyanurate (TAIC), meta-phenylene dimaleimide (MPDM), trimethyolpropane trimethacrylate (TMPTMA), trimethyolpropane triacrylate (TMPTA), polyhedral oligomeric silsesquioxane (POSS) compounds, and mixtures thereof. The non-porous membrane may also be EB-crosslinked with mixtures of two or more crosslinker additive compounds. For example, TAIC and POSS-based additive compounds may be added for enhanced E-beam crosslinking of the polymer fibers in the nonwoven separator. The non-porous membrane may also be composited with inorganic particle additives to enhance dimensional stability and mechanical properties of the separator during cell high temperature exposure. Particle additives can include, but are not limited to inorganic particles such as nanosized TiO₂, Al₂O₃, and SiO₂, and nanoclays.

The following examples are not intended to be limiting in any way.

### EXAMPLES

### Example 1

1a. Fabrication of Heat-Resistant Separator.

EB-crosslinked NF separators were prepared by electrospinning acetone solution mixtures of PVdF-co-HFP (product no. Solef 21508 from Solvay; polymer concentration was 9 wt %) copolymer and triallyl isocyanurate (TAIC; 0, 5, 7.5, and 10 wt % relative to the weight of the polymer) cross-linker, under a high-voltage electric field (25 kV). The electrospinning solution also contained NaI (0.1 wt % relative to total weight of solid polymer). A needle-based electrospinning machine was used for nanofiber production. A solution feed rate of 0.05 mL/min and gap distance of 10 cm between emitter and collector electrode were used during the electrospinning manufacturing process. FIGS. 5A-5C show the manufactured NF materials consisting of flexible, nonwoven membranes with uniform fiber size. The fiber size distribution, determined using FibraQuant™ fiber analysis software, is d ˜223 nm (±63 nm). Cross-linking of the manufactured NF membranes was done using a pilot scale, roll-to-roll EB machine at irradiation doses of 100, 400, 600, 800, and 1000 kGy.

1b. Evaluation of Separator Thermal Properties.

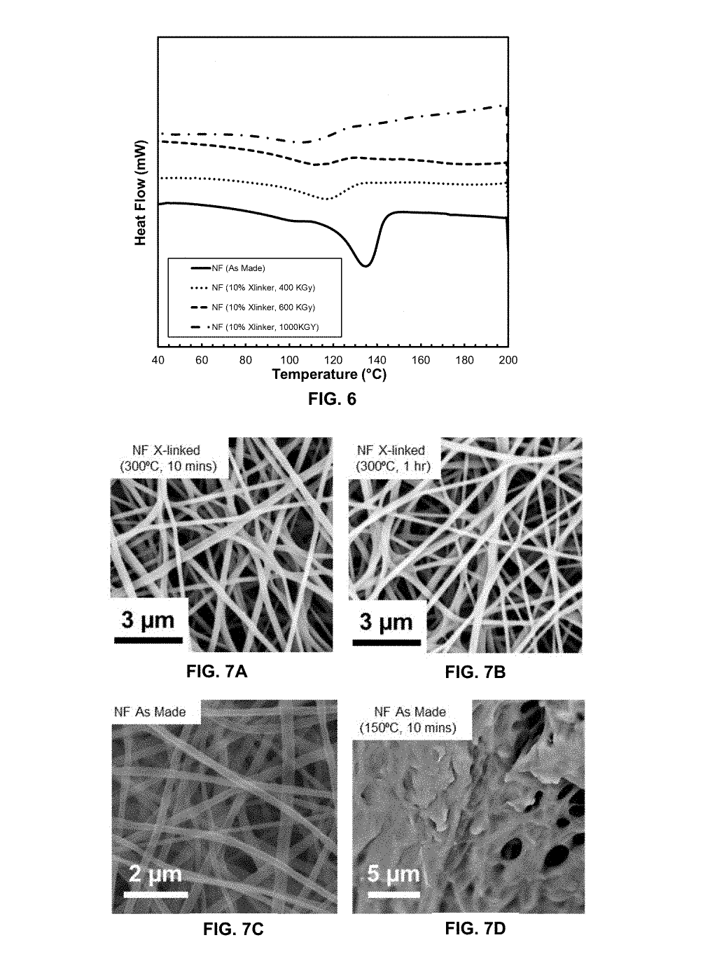

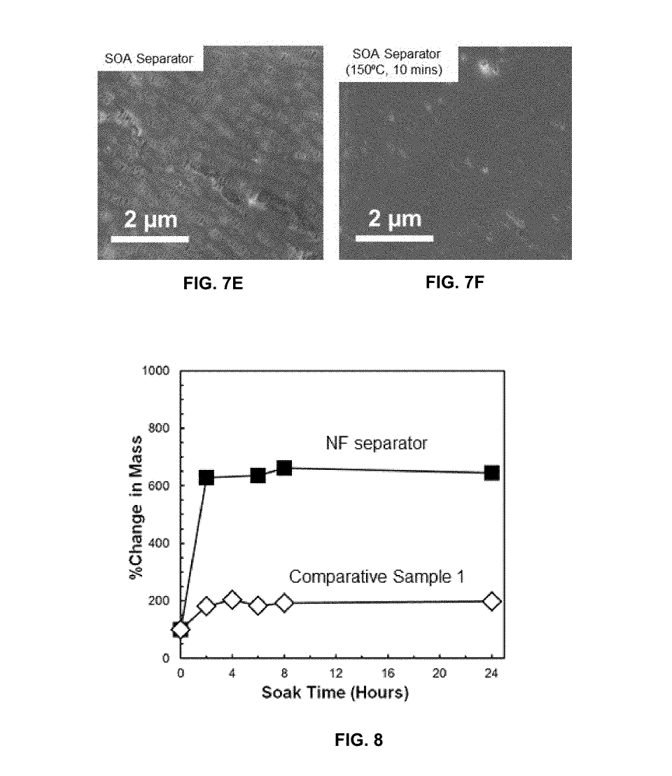

The thermal properties of EB-cross-linked NF separators were verified by differential scanning calorimetry (DSC) and high-temperature oven soak tests. DSC measurements showed a progressive decrease in the melting temperature and degree of crystallization (area under melting peak) of the PVdF-co-HFP copolymer with increasing EB irradiation dose, which indicated formation of high degree of chemically cross-linked polymer networks (FIG. 6). The melt integrity of the NF separators was evaluated by high-temperature oven soak tests. EB-irradiation cross-linking yielded polymer NF separator membranes that were melt-resistant even when exposed to a temperature of up to 300° C. (FIGS. 7A, 7B). In contrast, non-crosslinked NF samples (FIGS. 7C, 7D) and a standard state-of-the-art (SOA) commercial microporous separator (FIGS. 7E, 7F), melt at a substantially lower temperature (Tₘ˜150° C.). Because SOA commercial separators do not provide optimal safety protection against thermal abuse conditions, particularly when cell temperatures exceed the melting temperature of PE (Tₘ˜130° C.) and PP (Tₘ˜165° C.), this remarkable improvement in high-temperature melt resistance in the EB-crosslinked NF separators is key for reducing safety risks associated with unexpected battery cell failures that could lead to thermal runaway events. This enhanced thermal resistance enables substantially better protection against internal short circuits over a wide temperature range compared to SOA separators, and is particularly important in applications where battery devices are required to operate at extreme temperature conditions without posing safety hazard risks.

1c. Evaluation of Separator Electrolyte Wettability.

Electrolyte uptake and wettability are important performance parameters for evaluating Li-ion battery separators. Poor electrolyte uptake and wettability can lead to dry spots in the assembled cell that limit cell performance (e.g., increased cell resistance and limited cycle life). Furthermore, a poorly wetting separator requires time and cost-intensive manufacturing processes to ensure complete separator wet-out in the fabricated cell. Time-based electrolyte uptake measurements were done on EB-crosslinked NF and “Comparative Sample 1”. Separator samples were weighed dry, followed by immersion in electrolyte solution to allow full membrane saturation. Weight measurements were subsequently taken over an interval of 2 to 24 hrs after soaking in electrolyte. FIG. 8 shows that the EB-crosslinked NF separator absorbs substantially more electrolyte solvent compared to “Comparative Sample 1”; the maximum mass change after electrolyte soak tests was ˜600 wt % for EB-crosslinked NF compared to ˜200 wt % for “Comparative Sample 1”. This performance, which represents an improvement of 200% compared to “Comparative Sample 1”, is attributed to the inherently high porosity of electrospun nanofiber membranes (50-90% compared to 36-50% for commercial separators), and the ability of electrolyte solvent to wet and absorb into the cross-linked PVdF-co-HFP matrix. By comparison, standard commercial PE and PP separators trap electrolyte solvent exclusively within the membrane pore volume. The EB-crosslinked NF and “Comparative Sample 1” separators also showed excellent dimensional stability, with no recorded change in the X-Y plane after extended electrolyte soak tests.

1d. Evaluation of Separator Ionic Conductivity.

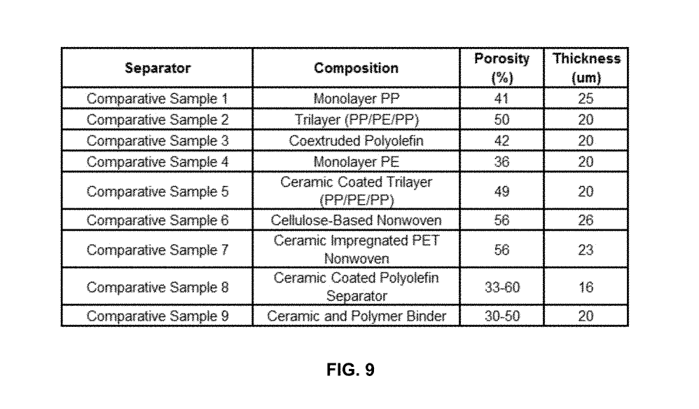

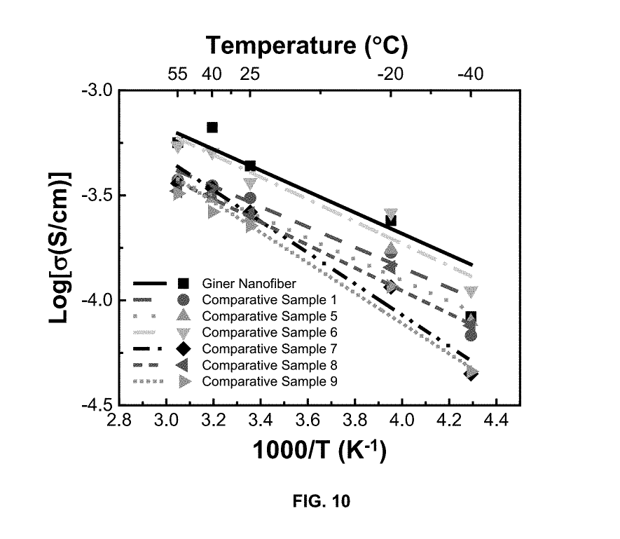

Separators that suffer from poor ionic conductivity can hinder high-rate battery operation. This limitation can result in increased internal resistance, as well as reduced cycle life, slower charging, and decreased power capability. The EB-crosslinked NF separator not only improves thermal resistance, but its highly porous, nonwoven structure also enhances Li-ion diffusion. To demonstrate this advantage, we measured and compared the ionic conductivity of EB-crosslinked NF separator against several comparative separator samples. (Specifications of benchmark separators are provided in FIG. 9.) Ionic conductivity measurements were made via AC impedance scans over a frequency range of 1-Hz to 1-MHz, and a 5-mV AC voltage input. FIG. 10 shows a substantial improvement in ionic conductivity from using the EB-crosslinked NF separator. For example, the room temperature ionic conductivity is 85% to 150% higher than benchmark separator samples. Because of its similar highly porous nonwoven structure Comparative Sample 6” is the only benchmark separator with ionic conductivity values that are comparable to the EB-crosslinked NF separator. Overall, this improvement in ionic conductivity across a wide temperature range (−40° C. to 55° C.), indicates a strong suitability for the described separator in demanding battery applications requiring high-rate performance.

### Example 2

### Electrochemical Evaluation of NF Separator.

2a. Continuous Rate Evaluation

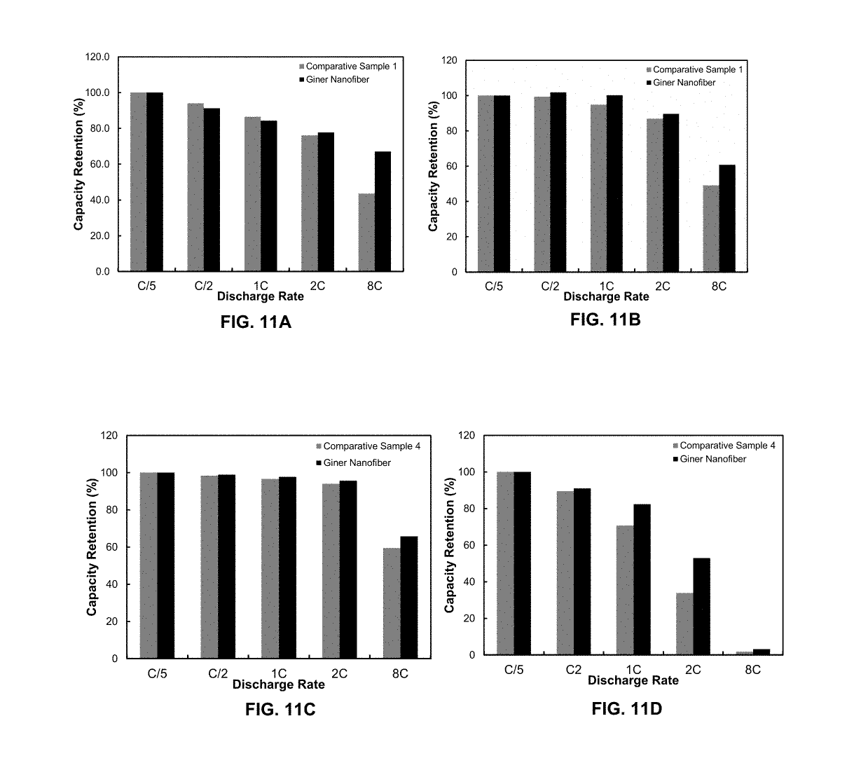

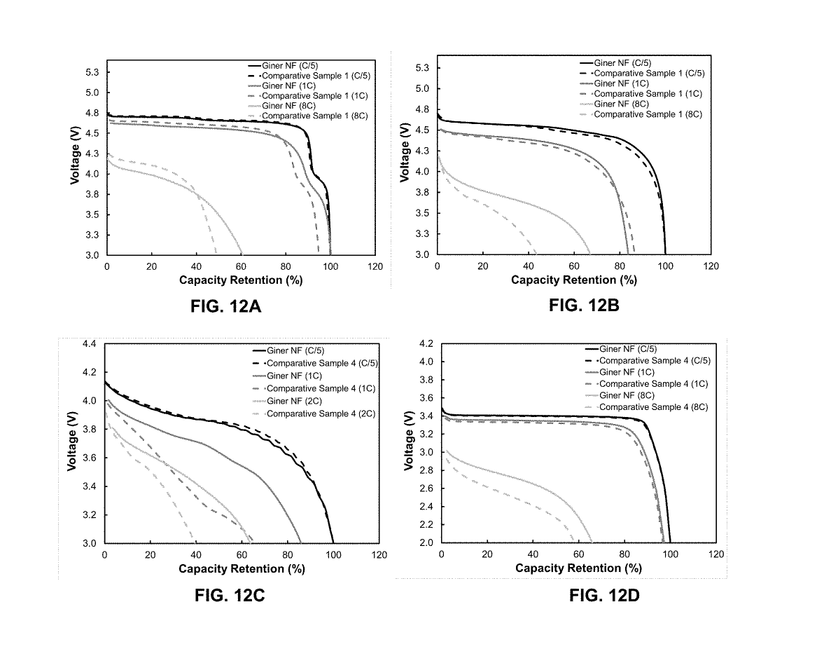

To demonstrate the impact of improved ionic conductivity on battery cell performance, the rate capability of cells with NF separator was benchmarked against “Comparative Sample 1” separator. Rate tests were done on high-voltage, LiNi_{0.5}Mn_{1.5}O₄ (LNMO) cathode cells built with two types of anodes (lithium metal and graphite carbon). Cells built with a Li anode are referred to as “half-cells”, while cells containing carbon anodes are referred to as “full-cells.” Continuous rate tests were done by charging cells under a constant-current (CC) to 100% state-of-charge (SOC) at a C/4 (4-hr) rate, and then continuously discharging at varying rates from C/5 (5-hr) to 8 C (8 min). The charge-discharge voltage window for the LNMO cells was 5 V to 3 V. FIGS. 11A, 11B and FIGS. 12A, 12B show that the EB-crosslinked separator provides a clear advantage over “Comparative Sample 1” in terms of improved capacity retention during fast discharging in both half-cells and full-cells. The performance benefits are best realized during high discharge rates. For example, the capacity retention of EB-crosslinked NF separator half-cells was ˜60% during a fast, 8-minute (8 C) discharge rate. This compares to a 50% capacity retention for “Comparative Sample 1” separator cells discharged at the same 8 C rate. In full-cells, the performance improvement from using the NF separator is even higher, with capacity retention of 70%, compared to 40% for “Comparative Sample 1”. Additionally, the EB-crosslinked NF separator cells also show higher average discharge voltage values when the discharge rate is increased, which indicates that NF separator-cells maintain a lower internal resistance (IR) compared to cells with the benchmark “Comparative Sample 1” separator.

To demonstrate the versatility of the EB-crosslinked NF separator, continuous discharge rate tests were also performed on cells assembled with standard commercial cathodes (LiFePO₄ and LiCoO₂), and results were benchmarked against a “Comparative Sample 4” separator (FIGS. 11C, 11D and FIGS. 12C, 12D). These tests showed a similar trend as described above, with the EB-crosslinked NF separator outperforming the benchmark separator sample in both capacity and average discharge voltage retention. Specifically, when “Comparative Sample 4” benchmark separator was replaced with the EB-crosslinked NF separator, the discharge capacity retention improved by 10% for LiFePO₄ (at 8 C), and 30% for LiCoO₂ (at 2 C).

2b. Pulse Rate Evaluation

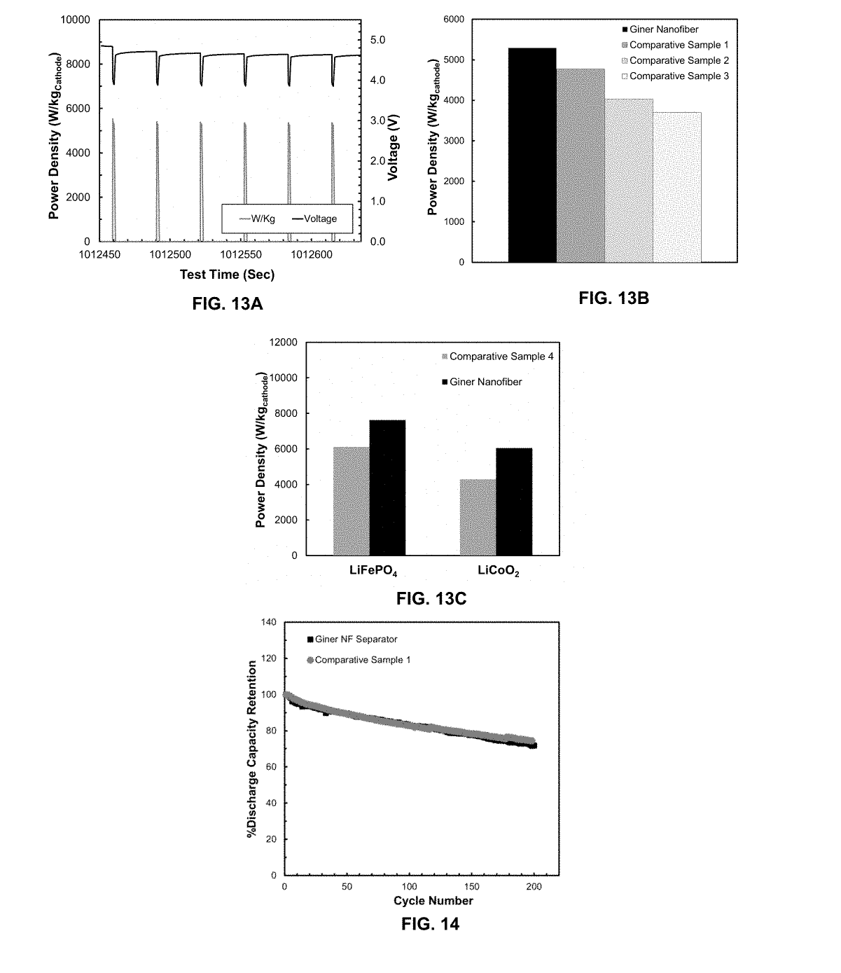

The rate performance of EB-crosslinked NF separators was also evaluated under a pulse discharge mode (FIG. 13A). These tests were done by discharging cells under high-rate, 1-sec pulse loads. (A 30-sec rest period was applied between each consecutive pulse.) Power density values based on the total cathode film weight (active material, binder, conductive carbon) were calculated and compared to benchmark separators. FIG. 13B shows that LNMO cells pulsed with EB-crosslinked NF separator provide higher average power density at 5.4 kW/kg_{cathode} compared to “Comparative Sample 1” (4.8 kW/kg_{cathode}), “Comparative Sample 2” (4 kW/kg_{cathode}), and “Comparative Sample 3” (3.7 kW/kg_{cathode}). This result represents improvements of 13%, 35%, and 46% compared to “Comparative Sample 1”, “Comparative Sample 2”, and “Comparative Sample 3” separators, respectively. The EB-crosslinked NF separator is also advantageous when used in combination with standard commercial cathodes. By switching to the NF separator, the power density improved by 30% for LiFePO₄, and 50% for LiCoO₂, compared to “Comparative Sample 4” (FIG. 13C).

2c. Cycle Life Evaluation

One of the life-limiting properties of a battery device is the number of charge-discharge cycles at a given depth-of-discharge (DOD). For applications that require a high number of charge-discharge cycles and several years of calendar life, it is critical that the battery separator is designed for safe and reliable long-term operation. For fully discharged cells (100% DOD), cycle life is typically defined as the cycle number at which discharge capacity falls below 80% of its initial value. FIG. 14 shows that the cycle life data of LNMO full-cells with NF separator is comparable to a benchmark “Comparative Sample 1,” which indicates good chemical and electrochemical compatibility with cell internal components for long-term battery use.

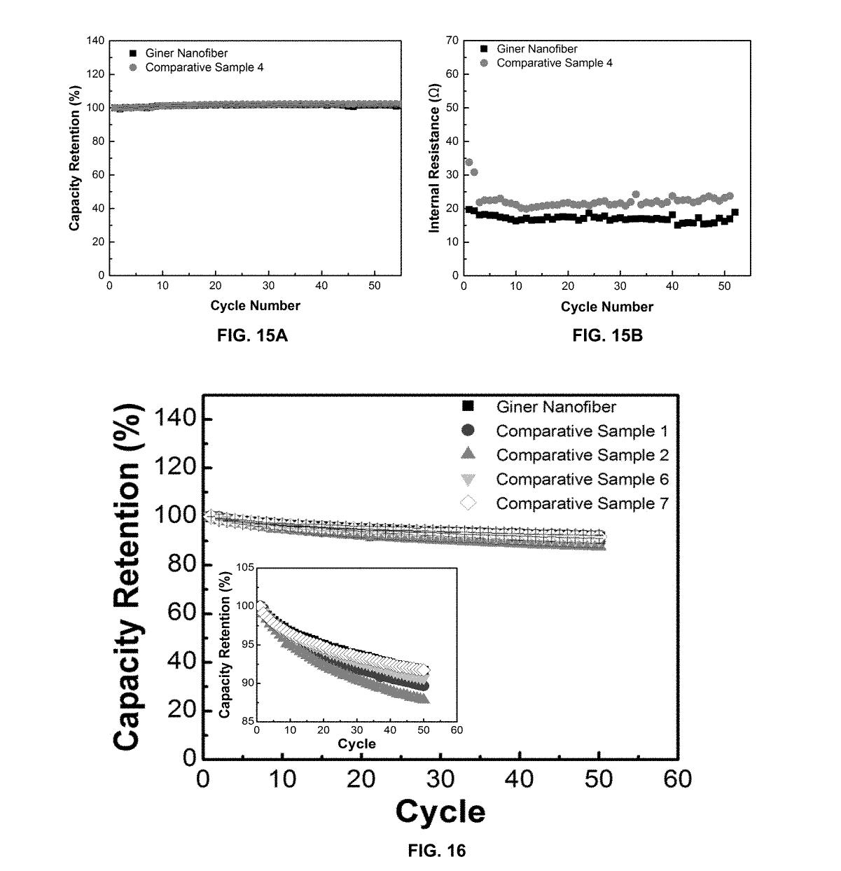

To further evaluate cycle performance of the EB-crosslinked NF separator, continuous cycling evaluations were also done on cells with commercial battery cathodes. LiFePO₄ cells with NF separator were cycled and compared to commercial “Comparative Sample 4” separator. FIGS. 15A, 15B show that the EB-crosslinked NF separator exhibits excellent cycle stability even when used in combination with commercial LiFePO₄ battery electrodes. The NF cell capacity retention and discharge capacity values were comparable to commercial “Comparative Sample 4”. We also measured the cell DC internal resistance (IR) during cycling to further probe the separator's impact on cell performance. These tests showed lower cell IR values for EB-crosslinked NF separator cells compared to benchmark separator cells. Lower cell IR minimizes internal heat generation, which may promote detrimental side reactions inside the cell during cycling. Therefore, minimization of cell IR is important for extending the battery's operational lifetime. Additionally, the performance of the NF separator was also compared to commercial benchmark separators in full cells constructed with standard commercial nickel-manganese-cobalt (NMC) cathode and graphite anode electrodes (FIG. 16). These results demonstrated that the NF separator is applicable to a wide variety of cell chemistries and in applications that require reliable and long-term use from the battery device.

2d. High-Temperature Performance

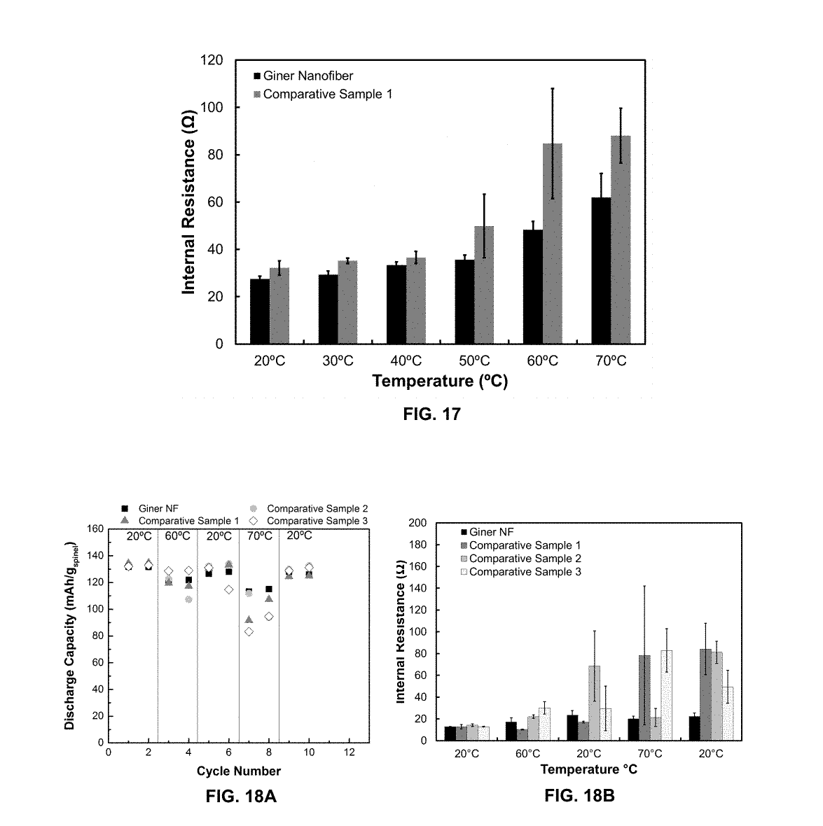

Because certain applications may require wide temperature operation, the performance of the NF separator was also evaluated in cells cycled over a wide temperature range. LNMO full-cells were cycled at a C/5 rate inside an environmental chamber from a temperature range of 20° C. to 70° C. After completion of 70° C. cycling, cells were immediately cooled and cycled at 20° C. to measure recoverable capacity. The NF and benchmark separator cells retain similar discharge capacity values when cycled up to 50° C. However, beyond 50° C., the EB-crosslinked NF separator shows a clear advantage. For example, the cell capacity retention at 70° C. for NF cells was ˜30%, compared to ˜17% for Celgard cells. Even more striking, benchmark separator cells failed to cycle at room temperature after exposure to 70° C. cycling. In contrast, the NF cells still delivered ˜25% of their original capacity under this same test condition. Cell IR data also tracked well with capacity retention trends. IR values during cycling at 50° C. to 70° C. were lower than Celgard cells (FIG. 17). Cycle stability of the EB-crosslinked NF separator was also evaluated in LNMO half-cells and benchmarked against three standard commercial separators (“Comparative Sample 1”, “Comparative Sample 2”, and “Comparative Sample 3”). Cells were cycled consecutively at 20° C., 60° C., 20° C., 70° C. and 20° C. Although discharge capacity retention values were comparable for all separator types (FIG. 18A), the measured cell IR immediately following 70° C. cycling was the lowest in NF cells compared to cells with standard commercial separators (FIG. 18B).

2e. Low-Temperature Performance

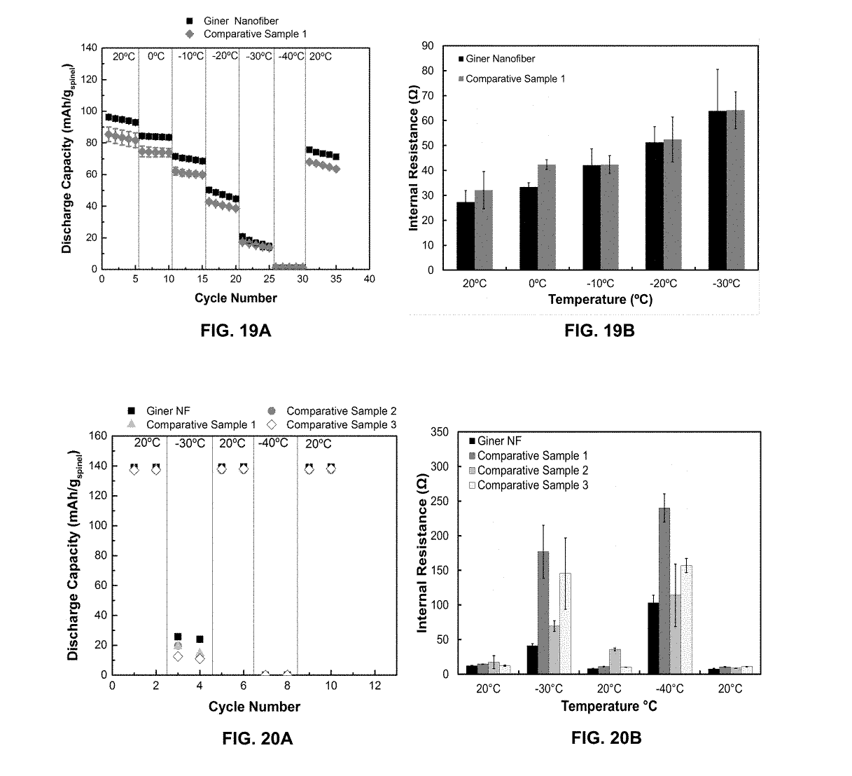

Low-temperature cycling of NF separators was performed in LNMO full-cells and results were compared to benchmark separator cells. Cells were cycled 5 times at a C/5 rate from 20° C. to −40° C. After −40° C. cycling, cells were cycled again at 20° C. to measure recoverable capacity. FIG. 19A shows that EB-crosslinked NF separator cells improve discharge capacity during low-temperature cycling compared to “Comparative Sample 1”. IR measurements of NF cells were similar to benchmark separator cells (FIG. 19B). The performance of EB-crosslinked NF separator LNMO half-cells was also evaluated at −30° C. and −40° C. (FIG. 20). The EB-crosslinked NF separator outperforms commercial separators when cycled at −30° C., providing up to 50% more discharge capacity. All cells recovered 100% of their discharge capacity after returning to room temperature from −30° C. and −40° C. cycling. FIG. 20 shows that EB-crosslinked NF separator cells exhibits lower IR values than commercial separators, with reductions of up to 75% and 60% at −30° C. and −40° C., respectively.

### REFERENCES

(1) Tarascon, J. M.; Armand, M. Nature 2001, 414, 359.
(2) Goodenough, J. B.; Kim, Y. Chemistry of Materials 2010, 22, 587.
(3) Armand, M.; Tarascon, J. M. Nature 2008, 451, 652.
(4) Lu, L.; Han, X.; Li, J.; Hua, J.; Ouyang, M. Journal of Power Sources 2013, 226, 272.
(5) Balakrishnan, P. G.; Ramesh, R.; Prem Kumar, T. Journal of Power Sources 2006, 155, 401.
(6) Wang, Q.; Ping, P.; Zhao, X.; Chu, G.; Sun, J.; Chen, C. Journal of Power Sources 2012, 208, 210.
(7) Arora, P.; Zhang, Z. Chemical Reviews 2004, 104, 4419.
(8) Zhang, S. S. Journal of Power Sources 2007, 164, 351.
(9) Kim, M.; Park, J. H. Journal of Power Sources 2012, 212, 22.
(10) Lee, J.-R.; Won, J.-H.; Kim, J. H.; Kim, K. J.; Lee, S.-Y. Journal of Power Sources 2012, 216, 42.
(11) Zhang, S. S.; Xu, K.; Jow, T. R. Journal of Power Sources 2005, 140, 361.
(12) Huang, X. Journal of Power Sources 2011, 196, 8125.
(13) Ramakrishna, S.; Fujihara, K.; Teo, W. E.; Lim, T. C.; Ma, Z. Electrospinning and nanofibers; World Scientific Publishing Co. Pte. Ltd.: Singapore, 2005.
(14) Andrady, A. L. Science and technology of polymer nanofibers; John Wiley & Sons, Inc.: Hoboken, N.J., 2008.
(15) Banik, I.; Bhowmick, A. K. Radiation Physics and Chemistry 1999, 54, 135.
(16) Berejka, A. J. Radiation Physics and Chemistry 1993, 42, 147.
(17) Bik, J.; Gluszewski, W.; Rzymski, W. M.; Zagórski, Z. P. Radiation Physics and Chemistry 2003, 67, 421.
(18) Kim, G.-H.; Smith, K.; Lee, K.-J.; Santhanagopalan, S.; Pesaran, A. Journal of The Electrochemical Society 2011, 158, A955.
(19) Kim, G.-H.; Smith, K.; Ireland, J.; Pesaran, A. Journal of Power Sources 2012, 210, 243.
(20) Gerver, R. E.; Meyers, J. P. Journal of The Electrochemical Society 2011, 158, A835.

The relevant teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. An electrochemical cell consisting of:
a) an anode;
b) a cathode; and
c) a heat-resistant separator between the anode and the cathode, the heat-resistant separator comprising a crosslinked membrane with a single-layer or multi-layer structure; and
d) an electrolyte

2. The electrochemical cell of claim 1, wherein the cell is a lithium-ion battery, lithium-sulfur battery, lithium-air battery, or capacitor.

3. The electrochemical cell of claim 1, wherein the crosslinked membrane is a nonwoven fiber mat.

4. The electrochemical cell of claim 1, wherein the crosslinked membrane is a porous membrane prepared by a phase inversion method.

5. The electrochemical cell of claim 1, wherein the crosslinked membrane is a nonporous membrane.

6. The electrochemical cell of claim 3, wherein the heat-resistant separator has porosity in a range of between about 30 to about 95%.

7. The electrochemical cell of claim 3, wherein the pores of the heat-resistant separator range in size from between about 1 nanometers (nm) to about 1000 nm.

8. The electrochemical cell of claim 3, wherein the fibers of the heat resistant separator have an average diameter in a range of between about 0.001 μm to about 10 μm.

9. The electrochemical cell of claim 3, wherein the fibers of the heat-resistant separator have one or more distinct average diameters.

10. The electrochemical cell of claim 1, wherein the heat-resistant separator is comprised of at least one member of the group consisting of a fluoropolymer, a polyamide, a polyether, a polyurethane, a polysulfone, a polyarylsulfone, a polyethersulfone, a polyphenylsulphone, a polyacrylonitrile, a polyacrylate, a polyvinyl pyrrolidone, a polyacrylic, a polystyrene, a polyacetal, a polycarbonate, a polyimide, a polyetherimide, a polystyrene, a polyolefin, a polyester, a polyvinyl alcohol, a polyvinyl halide, a polynorbornene, a polyalkylene sulfide, a polyarylene oxide, a poly(1,4-butanediol terephthalate), a poly(alkylene ether terephthalate), a (ether-ester-amide) copolymer, a polylaurinlactam, a polytetrahydrofuran, their copolymers, and mixtures thereof.

11. The electrochemical cell of claim 10, wherein the fluoropolymer includes at least one member of the group consisting of poly(vinylidene fluoride), poly(vinylidene fluoride-co-hexafluoropropylene), poly(vinylidene fluoride-co-tetrafluoroethylene), poly(vinylidene fluoride-co-chlorotrifluoroethylene), poly(vinylidene fluoride-co-hexafluoropropylene-co-tetrafluoroethylene), ethylene-tetrafluoroethylene copolymers, hexafluoropropylene-tetrafluoroethylene copolymers, tetrafluoroethylene-perfluoro(alkoxy alkane) copolymers, hexafluoropropylene-tetrafluoroethylene-ethylene terpolymers, fluorinated poly(meth)acrylate, and mixtures thereof.

12. The electrochemical cell of claim 10, wherein heat-resistant separator includes a crosslinker or polymerizable compound from at least one member of the group consisting of triallyl-cyanurate, triallyl-isocyanurate, meta-phenylene dimaleimide, trimethyolpropane trimethacrylate, polyhedral oligomeric silsesquioxane (POSS) compounds, and mixtures thereof.

13. The electrochemical cell of claim 12, wherein the functionalized polyhedral oligomeric silsesquioxane compounds include one member of the group consisting of acrylo POSS, methacryl POSS, vinyl POSS, trisnorbornenyllsobutyl POSS, acrylolsobutyl POSS, methacrylolsobutyl POSS, methacrylate isobutyl POSS, methacrylate ethyl POSS, methacrylethyl POSS, methacrylate isooctyl POSS, methacryllsooctyl POSS, norbornenylethyl disilanollsobutyl POSS, allysobutyl POSS, vinyllsobutyl POSS), and mixtures thereof.

14. The electrochemical cell of claim 1, wherein the heat-resistant separator has a melting point of more than 200° C. or does not melt.

15. The electrochemical cell of claim 1, wherein the heat-resistant separator includes a blend of a low-melting phase and a melt-resistant phase contained within the same layer or a low-melting phase and a melt-resistant phase located in distinct layers through the separator thickness.

16. The electrochemical cell of claim 15, wherein the low-melting phase has a melting point of less than 130° C.

17. The electrochemical cell of claim 15, wherein the melt-resistant phase has a melting point of more than 200° C.

18. The electrochemical cell of claim 1, wherein the heat-resistant separator is crosslinked by electron beam irradiation, gamma irradiation, or a combination of these methods.

19. The electrochemical cell of claim 1, wherein the heat-resistant separator is a laminate consisting of crosslinked membrane with a single-layer or multi-layer structure coated on one or both sides of a porous support carrier.

20. The electrochemical cell of claim 19, wherein the porous support carrier is a wet-laid nonwoven.

21. The electrochemical cell of claim 19, wherein the porous support carrier is a microporous polyolefin membrane.

22. The electrochemical cell of claim 19, wherein the porous support carrier is a porous membrane prepared by a phase inversion method.

23. The electrochemical cell of claim 1, wherein the heat-resistant separator has a thickness in a range of between about 10 μm to about 100 μm.

24. The electrochemical cell of claim 1, wherein heat-resistant separator includes inorganic particle additives selected from the group consisting of titanium dioxide (TiO₂), aluminum oxide (Al₂O₃), barium titanate (BaTiO₃), silicon dioxide (SiO₂), nanoclay, or a mixture thereof.

25. The electrochemical cell of claim 1, wherein the electrolyte is a liquid electrolyte.

26. A method for making an electrochemical cell, comprising the steps of:
a) fabricating a heat-resistant separator, the heat-resistant separator comprising a crosslinked membrane with a single of multi-layer structure; and
b) assembling an anode and a cathode on either side of the heat-resistant separator, and
c) adding a liquid electrolyte to thereby form an electrochemical cell.

27. The method of claim 26, wherein the electrochemical cell is a lithium-ion battery, lithium-sulfur battery, lithium-air battery, or capacitor.

28. The method of claim 26, wherein the heat-resistant separator is formed by a method that includes at least one member of the group consisting of electrospinning, melt-blowing, bi-component melt-blowing, island-sea melt-spinning, electro-blowing, and force spinning.

29. The method of claim 26, wherein the heat-resistant separator is crosslinked by electron beam irradiation or gamma, or combinations of these methods.

30. The method of claim 26, further including the step of laminating the heat resistant separator with at least one porous support carrier.

31. The method of claim 30, wherein the porous support carrier is a wet laid nonwoven

32. The method of claim 30, wherein the porous support carrier is a microporous polyolefin membrane.

33. The method of claim 30, wherein the porous support carrier is a porous membrane prepared by a phase inversion method.

34. The method of claim 30, wherein the heat-resistant separator is fabricated by coating at least one of the anode and the cathode.
